(19) United States
(12) Patent Application Publication
(10) Pub. No.: US 2014/0176065 A1
(43) Pub. Date: Jun. 26, 2014

(54) BATTERY CHARGING DEVICE FOR A HANDHELD MACHINE TOOL

(71) Applicants: Marcin REJMAN, Waiblingen (DE); Guenter LOHR, Leinfelden-Echterdingen (DE); Juergen MACK, Goeppingen (DE); Dragan KRUPEZEVIC, Stuttgart (DE)

(72) Inventors: Marcin REJMAN, Waiblingen (DE); Guenter LOHR, Leinfelden-Echterdingen (DE); Juergen MACK, Goeppingen (DE); Dragan KRUPEZEVIC, Stuttgart (DE)

(73) Assignee: ROBERT BOSCH GMBH, Stuttgart (DE)

(21) Appl. No.: 14/134,662

(22) Filed: Dec. 19, 2013

(30) Foreign Application Priority Data
Dec. 21, 2012 (DE) 10 2012 112 884.7

(51) Int. Cl. H02J 7/02

(52) U.S. Cl. CPC H02J 7/025
USPC 320/108

(57) ABSTRACT

A battery charging device of a handheld machine tool has a primary inductive charging unit provided to charge handheld machine tool battery devices using at least two different nominal voltages.

### BACKGROUND OF THE INVENTION

1. Field of the Invention

The present invention relates to a battery charging device for a handheld machine tool having a primary inductive charging unit.

2. Description of the Related Art

A battery charging device for a handheld machine tool having a primary inductive charging unit has already been proposed.

### BRIEF SUMMARY OF THE INVENTION

The present invention provides a battery charging device for a handheld machine tool, which has a primary inductive charging unit.

The primary inductive charging unit is provided for charging handheld machine tool battery devices using at least two different nominal voltages. Preferably, the primary inductive charging unit is provided for charging battery devices of handheld machine tools using at least two essentially different nominal voltages. In this context, a “battery charging device of a handheld machine tool” in particular means a device for charging battery devices of handheld machine tools, in particular accumulators. The device preferably has at least one control and/or regulator unit, which is provided to control and/or regulate a charging operation. Particularly preferably, this describes an inductive charging device. Furthermore, a “primary inductive charging unit” in this connection is to be understood in particular as an inductive charging unit that is provided to convert electrical energy into a magnetic field, which may be converted into electrical energy again by a secondary inductive charging unit. An “inductive charging unit” in this connection in particular means a unit that is provided to convert electrical energy into a magnetic field, or a magnetic field into electrical energy. Preferably, this is to be understood as a component of an inductive charging device that is provided to transmit energy from a charging device to a battery device, in particular at least partially in contactless manner, by induction. The inductive charging unit particularly preferably has at least one charge coil. A “charge coil” in this context in particular means an element that is embodied at least partially by an electrical conductor, in particular a wound electrical conductor, which is disposed at least partially in the form of a circular disk. Preferably, a voltage is induced in the electrical conductor when a magnetic field is applied. “Provided” in particular means specially programmed, designed and/or equipped. Furthermore, a “handheld machine tool battery device” in particular refers to a battery device for a handheld machine tool. A “battery device” in particular describes a device for the temporary storage of electrical energy, in particular an accumulator. Preferably, this is to be understood in particular as a rechargeable storage device. Various battery devices that seem useful to one skilled in the art are conceivable, but in the present case, the battery device in particular is to be understood as a lithium-ion accumulator. Furthermore, a “handheld machine tool” in this instance in particular refers to a machine tool which processes work pieces, but it advantageously refers to a drilling machine, a drilling and/or percussion hammer, a saw, a planer, a screwdriver, a milling tool, a grinder, an angle grinder, a gardening device and/or a multifunctional tool. In addition, a “nominal voltage” in particular describes a specific value of an electrical voltage of handheld machine tool battery devices during standard operation. “Essentially different” in particular means that the nominal voltages differ from each other by at least 5%, preferably at least 10%, and especially preferably, by at least 15% of the higher nominal voltage.

Because of the development of the battery charging device of a handheld machine tool according to the invention, it is advantageously possible to charge different handheld machine tool battery devices, especially battery devices for handheld machine tools using different nominal voltages.

It is furthermore suggested that the primary inductive charging unit is provided to charge handheld machine tool battery devices using at least three different nominal voltages. Preferably, the primary inductive charging unit is provided for charging handheld machine tool battery devices using at least three essentially different nominal voltages. This in particular makes it possible to charge at least three different handheld machine tool battery devices, in particular handheld machine tool battery devices using different nominal voltages.

It is moreover the case that the primary inductive charging unit has at least two charge coils, which are provided to charge handheld machine tool battery devices using a nominal voltage that differs from that of the other charge coil. This especially advantageously allows the realization of different nominal voltages. Moreover, especially in a spatially separate placement of the charge coils, it is possible to realize particularly uncomplicated charging of handheld machine tool battery devices using at least two different nominal voltages.

As an alternative or in addition, the primary inductive charging unit has at least two charge coils, which are provided to charge, separately and/or in combination, handheld machine tool battery devices using at least two different nominal voltages. Preferably, the at least two charge coils are provided to charge handheld machine tool battery devices using at least three different nominal voltages, either individually and/or in combination. This especially advantageously allows the realization of different nominal voltages. Furthermore, this also makes it possible to provide an especially small-sized primary inductive charging unit, with the aid of which at least two different nominal voltages are able to be realized.

Moreover, the primary inductive charging unit is provided to actuate at least one of the at least two charge coils as a function of a handheld machine tool battery device to be charged. This advantageously makes it possible to realize a required nominal voltage. In addition, operator errors, in particular, are able to be avoided in this way because only a charge coil that is suitable is actuated.

As an alternative or in addition, the handheld machine tool battery device is equipped with at least one control and/or regulator unit, which controls and/or regulates a voltage flowing through a charge coil of the primary inductive unit, and adapts it to a nominal voltage of a handheld machine tool battery device. In this context, a “control and/or regulator unit” in particular refers to an electronic unit, which preferably is provided to control and/or regulate at least one parameter of the primary inductive charging unit. The control unit preferably includes a processing unit and, additionally to the processing unit, in particular, a memory unit having a control and/or regulator program stored thereon, which is to be executed by the processing unit. In this way, it is advantageously possible to adapt a charge voltage to a nominal voltage of the handheld machine tool battery device in an uncomplicated manner.

Furthermore, the battery charging device of a handheld machine tool has at least one processing unit, which is provided to analyze at least one parameter of a nominal voltage of a handheld machine tool battery device. A “processing unit” in particular means a unit having information input, information processing, and information output, in particular. The processing unit advantageously includes at least one processor, a memory, input and output means, additional electrical components, an operating program, regulation routines, control routines and/or calculation routines. The components of the processing unit preferably are situated on a shared circuit board and/or are advantageously disposed inside a shared housing. Furthermore, a “parameter of a nominal voltage” in particular describes a parameter which at least partially represents and/or describes a nominal voltage, and/or which at least partially makes it possible to infer a nominal voltage. A parameter of a nominal voltage is able to be detected and/or read out in this way in an especially advantageous manner. Furthermore, in particular, a handheld machine tool battery device is advantageously able to be charged at a required nominal voltage.

Furthermore, the handheld machine tool battery charging device includes at least one communication unit which is provided to receive and/or read out at least one parameter of a nominal voltage of a handheld machine tool battery device. In this context, a “communication unit” in particular refers to a unit which is provided to exchange data and/or control signals. Preferably, this means a unit provided to at least transmit data and/or control signals actively and/or passively, to a receiving unit, in particular. In this context, a transmission may take place in analog and especially, digital manner. Moreover, a transmission may be carried out in wireless as well as wire-bound manner. Various wireless transmitting techniques that are considered useful by one skilled in the art are conceivable, such as via Bluetooth, WLAN, UMTS, NFC or via an optical interface. Moreover, various wire-bound transmitting techniques that appear useful to one skilled in the art are conceivable. In this context, “active and/or passive” in particular means that data and/or control signals are able to be transmitted completely actively, completely passively, partially actively or varyingly actively, passively or partially actively. In this context, “passively” in particular means that the data are read out for transmission by the charging device. Furthermore, “partially active” means that the data and/or control signals are transmitted actively only in part. In this way it is easily and advantageously possible to receive and/or read out at least one parameter of a nominal voltage of the handheld machine tool battery device for the processing unit.

Furthermore, the processing unit is provided to analyze a cell number of a cell unit and/or a type of circuit of an electronic unit of a handheld machine tool battery device. A “cell number” in particular means a number of cell elements of a cell unit. Preferably, it refers in particular to a number of cell elements of a cell unit which are switched in series. Furthermore, a “cell unit” in this case in particular refers to a part of a battery device which is directly provided to store electrical energy on a temporary basis. Preferably, it means a unit that is provided to store electrical energy temporarily on an electrochemical basis, in particular. Preferably, this is to be understood as a rechargeable unit. The cell unit particularly preferably is made up of one or more cell element(s) which is/are especially connected to one another electrically. Various cell elements that seem useful to one skilled in the art are conceivable, but in particular, lithium-ion cells. “A type of circuit” in this instance in particular means a structure and/or preferably a function of a circuit. In addition, a “circuit” refers to an electronic circuit, in particular. Preferably, it relates to an interconnection of electrical and/or electronic components. In this way, it is advantageously possible to infer a nominal voltage of a handheld machine tool battery device in an uncomplicated manner. Furthermore, a battery device of a handheld machine tool is advantageously able to be charged at a required nominal voltage.

In addition, the battery charging device of a handheld machine tool has at least one communication unit, which is provided to detect and/or read out a cell number of a cell unit and/or a type of circuit of an electronic unit of the handheld machine tool battery device. In this way it is advantageously possible to receive and/or read out at least a cell number of a cell unit and/or a type of circuit of an electronic unit of the handheld machine tool battery device for the processing unit in an especially uncomplicated manner.

Furthermore, a system is provided, which has at least one first handheld machine tool battery device, at least one second handheld machine tool battery device, and a battery charging device for a handheld machine tool, which is provided to inductively transmit charge energy to at least one of the handheld machine tool battery devices during a charging operation. Furthermore, in this connection, a “charging operation” is to be understood in particular as an operating state in which the cell unit of the battery device is supplied with energy externally. Preferably, this refers in particular to an operating state in which the cell unit of the battery device temporarily stores the energy supplied externally.

Moreover, the first handheld machine tool battery device has a secondary inductive charging unit which includes a first charge coil, and the second handheld machine tool battery device has a secondary inductive charging unit, which has a second charge coil that differs from the first charge coil of the first handheld machine tool battery device. Preferably, the handheld machine tool battery charging device additionally includes at least one charge coil, which is embodied by a standard charge coil. A “secondary inductive charging unit” in this connection in particular is an inductive charging unit that is provided to convert a magnetic field into electrical energy. Preferably, it specifically refers to an inductive charging unit provided to charge a cell unit of the handheld machine tool battery device with energy transmitted by the battery charging device of a handheld machine tool. In this way, it is advantageously possible to adapt a charge coil of a handheld machine tool battery device to a required nominal voltage of the handheld machine tool battery device. Moreover, it is possible, in particular, to adapt a required energy transmission by adapting the charge coil of the handheld machine tool battery device. In addition, in the case of a standard charge coil of the battery charging device of a handheld machine tool, this makes it possible in particular that only the charge coils of the handheld machine tool battery devices must be adapted to a nominal voltage of the individual handheld machine tool battery device, so that different nominal voltages are able to be charged on the battery charging device of a handheld machine tool.

It is furthermore provided that the second charge coil of the second handheld machine tool battery device has dimensions that differ from those of the first charge coil of the first handheld machine tool battery device. Various dimensions that appear useful to one skilled in the art are conceivable.

Preferably, however, this refers especially to a different main extension of the coil. In this context, a “main extension of the coil” in particular means an extension of a longest edge of a smallest geometrical rectangular parallelepiped, which just barely still encloses the charge coil in its entirety. In this way, it is advantageously possible to achieve a different energy transmission to the first charge coil in comparison with the second charge coil. In particular, this allows a different transmission of a nominal voltage to the first charge coil in comparison with the second charge coil.

It is furthermore the case that the handheld machine tool battery device has at least one cell unit that encompasses at least one cell element using a voltage of at least approximately 3.6 Volt. “At least approximately” in this context in particular means that a deviation from a predefined value amounts in particular to less than 35%, preferably less than 25%, and especially preferably, to less than 15% of the predefined value. In this way in particular an advantageous handheld machine tool battery device having an advantageous cell unit is able to be furnished. In the case of a uniform voltage of the cell elements, it is thereby possible to infer a nominal voltage using no more than a cell number.

The battery charging device of a handheld machine tool according to the invention, the handheld machine tool battery device according to the invention, and the system according to the invention are not to be restricted to the afore-described uses and embodiments. In particular, in order to fulfill a method of functioning described herein, the battery charging device of a handheld machine tool according to the present invention, the handheld machine tool battery device, and the system according to the present invention in particular may have a number of described elements, components and units that deviates from a number mentioned herein.

### BRIEF DESCRIPTION OF THE DRAWINGS

FIG. 1 shows a schematic representation of a battery charging device of a handheld machine tool having a primary inductive charging unit and three handheld machine tool battery devices, each having a secondary inductive charging unit.

FIG. 2 shows a subsection of the battery charging device of a handheld machine tool according to the present invention, and one of the handheld machine tool battery devices in a schematic sectional view along cutting line II.

FIG. 3 shows a schematic representation of an alternative battery charging device of a handheld machine tool having a primary inductive charging unit and three handheld machine tool battery devices, each being equipped with a secondary inductive charging unit.

FIG. 4 shows an alternative battery charging device of a handheld machine tool and one of the handheld machine tool battery devices according to the present invention, in a schematic sectional view along cutting line IV.

FIG. 5 shows a schematic representation of a further alternative battery charging device of a handheld machine tool having a primary inductive charging unit and three handheld machine tool battery devices, each having a secondary inductive charging unit.

FIG. 6 shows the further alternative battery charging device of a handheld machine tool and one of the handheld machine tool battery devices according to the present invention, in a schematic sectional view along cutting line IV.

### DETAILED DESCRIPTION OF THE INVENTION

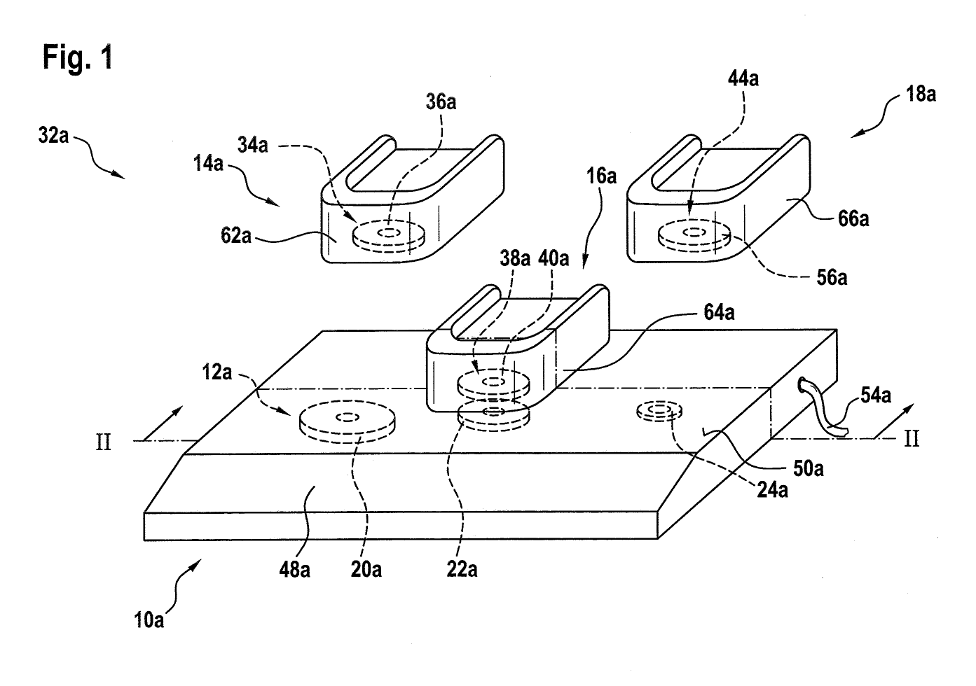

FIG. 1 shows a battery charging device 10a of a handheld machine tool, which includes a primary inductive charging unit 12a and three handheld machine tool battery devices 14a, 16a, 18a having a secondary inductive charging unit 34a, 38a, 44a in each case. Battery charging device 10a of a handheld machine tool is provided for the inductive transmission of charge energy to at least one of handheld machine tool battery devices 14a, 16a, 18a. Primary inductive charging unit 12a is provided for the wireless transmission of energy from battery charging device 10a of the handheld machine tool to one of handheld machine tool battery devices 14a, 16a, 18a. Primary inductive charging unit 12a is provided to convert electrical energy into a magnetic field, which in turn is able to be converted into electrical energy again by one of secondary inductive charging units 34a, 38a, 44a. Primary inductive charging unit 12a charges handheld machine tool battery devices 14a, 16a, 18a using three different nominal voltages. Each one of the three handheld machine tool battery devices 14a, 16a, 18a is charged using a nominal voltage that differs from that of the other two handheld machine tool battery devices 14a, 16a, 18a.

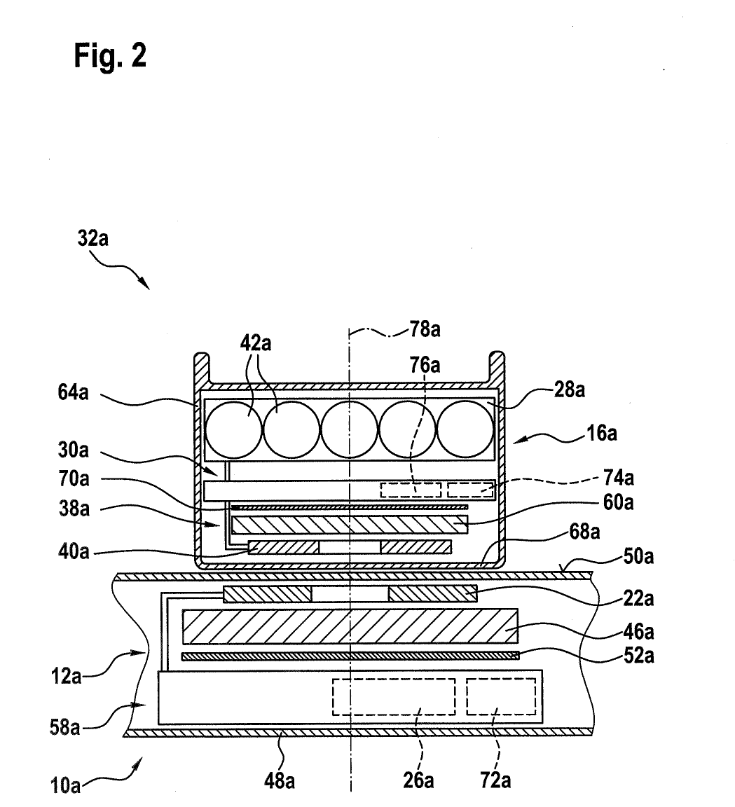

In addition, primary inductive charging unit 12a has three charge coils 20a, 22a, 24a. Charge coils 20a, 22a, 24a are provided to charge one of handheld machine tool battery devices 14a, 16a, 18a using a nominal voltage that differs from the nominal voltage of the other two charge coils 20a, 22a, 24a. Charge coils 20a, 22a, 24a are embodied in the form of a ring. Charge coils 20a, 22a, 24a are made up of a plurality of electrical conductors, which extend in the circumferential direction. The electrical conductors are wound about a winding axis 78a in the circumferential direction in each case. Winding axes 78a of charge coils 20a, 22a, 24a are situated in parallel at a distance from each other. The three charge coils 20a, 22a, 24a are situated next to each other at a distance. Each of the three charge coils 20a, 22a, 24a is assigned one core unit 46a and one electronic unit 58a. Core units 46a have been designed in the form of a plate and are made from a magnetic material (FIG. 2).

Battery charging device 10a of the handheld machine tool includes a housing unit 48a. Housing unit 48a forms a charge surface 50a. Handheld machine tool battery devices 14a, 16a, 18a are placed on charge surface 50a during a charging operation. Charge surface 50a extends parallel to a subsurface in a provided stand and faces away from the subsurface. Charge surface 50a extends across three charge coils 20a, 22a, 24a. Charge surface 50a is provided to accommodate handheld machine tool battery devices 14a, 16a, 18a for a charging operation. Handheld machine tool battery devices 14a, 16a, 18a are able to be placed separately on charge surface 50a above each of the three charge coils 20a, 22a, 24a.

Primary inductive charging unit 12a is situated completely inside housing unit 48a. Starting from charge surface 50a of housing unit 48a and proceeding in the direction of a center of battery charging device 10a of a handheld machine tool, charge coils 20a, 22a, 24a of primary inductive charging unit 12a come first, followed by core units 46a of primary inductive charging unit 12a, shielding units 52a, and electronic units 58a. Shielding units 52a are provided to protect electronic units 58a from interference effects of charge coils 20a, 22a, 24a, and vice versa. Electronic units 58a are connected to the energy supply by a cable 54a (not shown further). FIG. 2 shows a structure and sequence of the components and units merely for the particular components and units that are assigned to charge coil 22a. However, the structure and sequence is also applicable to the components and units that are assigned to the two charge coils 20a, 24a (FIG. 2).

The three handheld machine tool battery devices 14a, 16a, 18a each have a cell unit 28a for the storage of energy. Cell units 28a are provided to supply handheld machine tools (not shown further) with energy. Cell units 28a of handheld machine tool battery devices 14a, 16a, 18a have a plurality of cell elements 42a in each case, each using a voltage of approximately 3.6 Volt. Cell elements 42a of a cell unit 28a are interconnected in electrically conductive manner in a series connection. The cell unit (not shown further) of first handheld machine tool battery device 14a has three cell elements, each embodied by lithium-ion cells. The cell unit (not shown further) of first handheld machine tool battery device 14a has a nominal voltage of approximately 10.8 Volt. Cell unit 28a of second handheld machine tool battery device 16a has five cell elements 42a, each embodied by lithium-ion cells. Cell unit 28a of second handheld machine tool battery device 16a has a nominal voltage of approximately 18 Volt. The cell unit (not visible) of third handheld machine tool battery device 18a has four cell elements, each embodied by lithium-ion cells. The cell unit (not shown further) of third handheld machine tool battery device 18a has a nominal voltage of approximately 14.4 Volt (FIG. 2).

With the exception of a number of cell elements 42a of cell units 28a, handheld machine tool battery devices 14a, 16a, 18a have an identical design. Handheld machine tool battery devices 14a, 16a, 18a have a housing unit 62a, 64a, 66a, respectively. Cell units 28a are situated in the respective housing unit 62a, 64a, 66a of the individual handheld machine tool battery device 14a, 16a, 18a. In addition, handheld machine tool battery devices 14a, 16a, 18a include secondary inductive charging unit 34a, 38a, 44a in each case, for the charging of cell units 28a. Secondary inductive charging units 34a, 38a, 44a are provided for the wireless energy transmission for a charging operation of cell units 28a. Secondary inductive charging units 34a, 38a, 44a have a charge coil 36a, 40a, 56a, respectively, and a core unit 60a. Charge coils 36a, 40a, 56a are embodied in the form of a ring. Charge coils 36a, 40a, 56a are made up of a plurality of electrical conductors, which extend in the circumferential direction. The electrical conductors are wound about a winding axis 78a in the circumferential direction. Core units 60a are embodied in the form of plates and made from a magnetic material. Secondary inductive charging units 34a, 38a, 44a are disposed between the individual cell unit 28a and a housing wall 68a of individual housing unit 62a, 64a, 66a of the particular handheld machine tool battery device 14a, 16a, 18a. In the case of the three handheld machine tool battery devices 14a, 16a, 18a, charge coil 36a, 40a, 56a comes first when viewed starting from housing wall 68a in the direction of cell unit 28a, followed by core unit 60a, a shielding unit 70a, and an electronic unit 30a. Shielding units 70a are provided to protect electronic units 30a from interference effects of charge coil 36a, 40a, 56a, and vice versa (FIG. 2).

Battery charging device 10a of the handheld machine tool has three processing units 26a, which analyze at least one parameter of a nominal voltage of one of handheld machine tool battery devices 14a, 16a, 18a. Processing units 26a are provided to analyze a cell number of cell unit 28a of handheld machine tool battery devices 14a, 16a, 18a. Processing units 26a are provided to analyze a number of cell elements 42a of cell unit 28a of handheld machine tool battery devices 14a, 16a, 18a and to infer a nominal voltage therefrom. Each one of the three processing units 26a is assigned to one of the three charge coils 20a, 22a, 24a of battery charging device 10a of the handheld machine tool. However, it would basically also be conceivable that battery charging device 10a of the handheld machine tool battery device has only one processing unit for all three charge coils 20a, 22a, 24a. Processing units 26a in each case constitute part of electronic unit 58a (FIG. 2) associated with individual charge coil 20a, 22a, 24a.

Battery charging device 10a of the handheld machine tool has three communication units 72a, which read out at least one parameter of a nominal voltage of one of handheld machine tool battery devices 14a, 16a, 18a. Communication units 72a are provided to read out a cell number of cell unit 28a of handheld machine tool battery devices 14a, 16a, 18a. The three communication units 72a are connected to one of processing units 26a in each case. Communication units 72a likewise constitute part of electronic unit 58a associated with individual processing unit 26a. Communication units 72a are embodied by an NFC interface in each instance. Handheld machine tool battery devices 14a, 16a, 18a also have a separate communication unit 74a for this purpose. Communication units 74a of handheld machine tool battery devices 14a, 16a, 18a are embodied by a separate NFC interface as well. Communication units 74a constitute part of electronic unit 30a (FIG. 2) of individual handheld machine tool battery device 14a, 16a, 24a (FIG. 2).

Handheld machine tool battery devices 14a, 16a, 18a have a separate storage unit 76a, which is provided for the non-volatile storage of a number of cell elements 42a of individual cell units 28a of handheld machine tool battery devices 14a, 16a, 18a. Memory units 76a are embodied by a nonvolatile memory. Memory units 76a represent part of individual electronic unit 30a in each case. Memory units 76a are connected to respective communication unit 74a (not shown further). Communication units 72a are able to read out a stored number, via communication units 74a of handheld machine tool battery devices 14a, 16a, 18a, and to transmit it to processing units 26a. The nominal voltage of a cell element 42a is stored on processing units 26a, which makes it possible for processing units 26a to infer a nominal voltage of individual cell unit 28a. It would basically also be conceivable that a coil main extension of the individual charge coil 36a, 40a, 56a is stored on memory unit 76a of handheld machine tool battery devices 14a, 16a, 18a. In this way processing units 26a could analyze which particular charge coil 20a, 22a, 24a of primary inductive charging unit 12a of the handheld machine tool is suitable for the particular handheld machine tool battery device 14a, 16a, 18a (FIG. 2).

Primary inductive charging unit 12a is provided to actuate one of the three charge coils 20a, 22a, 24a as a function of a handheld machine tool battery device 14a, 16a, 18a to be charged. Primary inductive charging unit 12a is provided to actuate one of the three charge coils 20a, 22a, 24a as a function of a nominal voltage of handheld machine tool battery device 14a, 16a, 18a to be charged. If one of handheld machine tool battery devices 14a, 16a, 18a is placed on charge surface 50a, one of communication units 72a of primary inductive charging unit 12a reads out a number of cell elements 42a of handheld machine tool battery device 16a, using communication unit 74a of handheld machine tool battery device 16a seated on the charge surface. Processing unit 26a, which is connected to corresponding communication unit 72a, analyzes the number of cell elements 42a and calculates a nominal voltage on that basis. Because of the calculated nominal voltage, a suitable charge coil is then selected from among the three charge coils 20a, 22a, 24a and actuated for a charging operation. Via an output unit (not shown further), an operator is shown above which one of the three charge coils 20a, 22a, 24a the particular handheld machine tool battery device 16a is to be positioned.

Battery charging device 10a of the handheld machine tool and battery devices 14a, 16a, 18a of the handheld machine tool make up a system 32a.

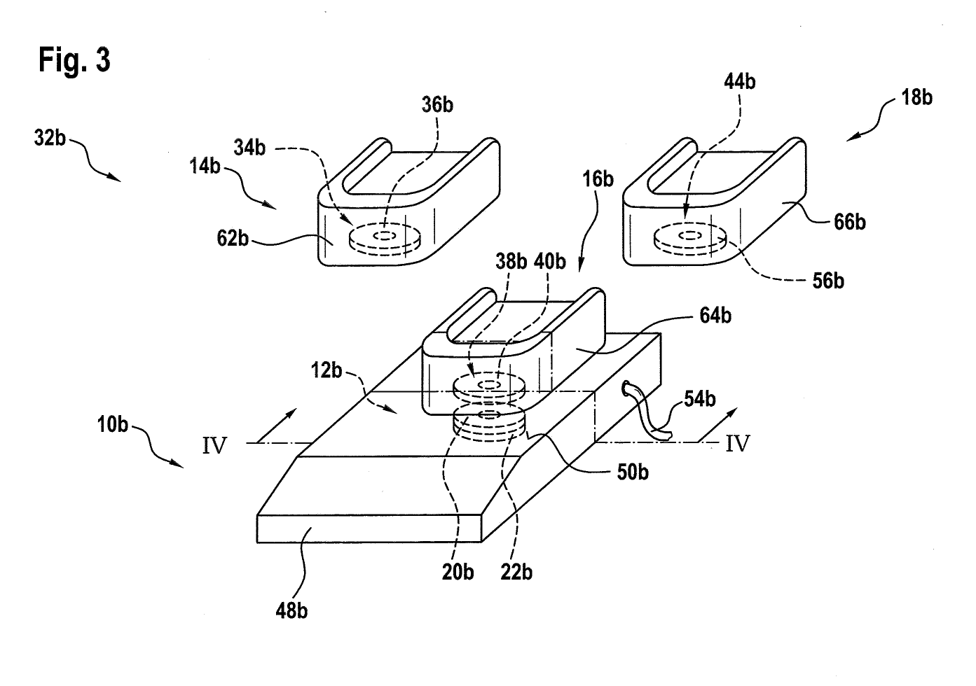

Two further exemplary embodiments of the present invention are shown in FIGS. 3 through 6. The following descriptions and the drawing are limited essentially to the differences between the exemplary embodiments. Regarding components that are designated in the same way, particularly regarding components having identical reference numerals, it is fundamentally possible to refer also to the figures and/or the description of the other exemplary embodiments, especially of FIGS. 1 and 2. In order to distinguish the exemplary embodiments, the letter a has been added after the reference numerals of the exemplary embodiment in FIGS. 1 through 2. In the exemplary embodiments of FIGS. 3 through 6, the letter a has been replaced by the letters b and c.

FIG. 3 shows an alternative battery charging device 10b of a handheld machine tool according to the present invention, which includes a primary inductive charging unit 12b and three handheld machine tool battery devices 14b, 16b, 18b having a secondary inductive charging unit 34b, 38b, 44b in each case. Primary inductive charging unit 12b has two charge coils 20b, 22b. Charge coils 20b, 22b are provided to charge handheld machine tool battery devices 14b, 16b, 18b using three different nominal voltages, either individually or in combination. Handheld machine tool battery devices 14b, 16b, 18b are charged using an appropriate nominal voltage according to a required nominal voltage. Charge coils 20b, 22b are developed in the form of a ring. Charge coils 20b, 22b are made up of a plurality of electrical conductors, which extend in the circumferential direction. The electrical conductors are wound about a winding axis 78b in the circumferential direction. Winding axes 78b of charge coils 20b, 22b are identical. Charge coils 20b, 22b are situated one behind the other when viewed along winding axis 78b. Charge coils 20b, 22b are situated at a distance from each other when viewed along winding axis 78b. However, it would basically also be conceivable to place charge coils 20b, 22b directly next to each other, or it would be conceivable for one of charge coils 20b, 22b to surround the other charge coil of charge coils 20b, 22b in a plane perpendicular to winding axis 78b. A shared core unit 46b and a shared electronic unit 58b are assigned to charge coils 20b, 22b. Core unit 46b is embodied as a plate and made from a magnetic material (FIG. 2).

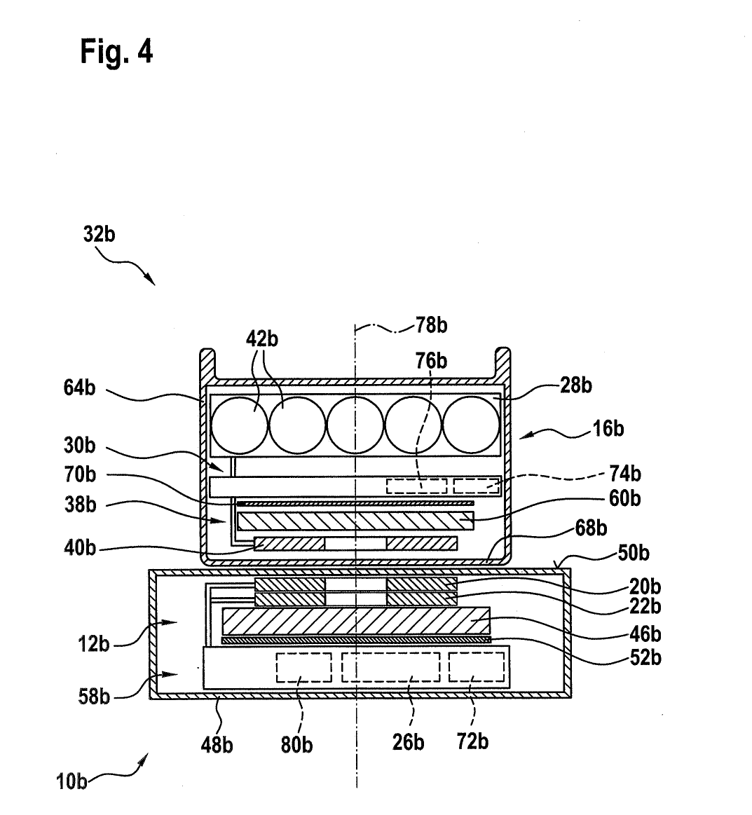

Primary inductive charging unit 12b is situated completely within a housing unit 48b battery charging device 10b of the handheld machine tool. Starting from a charge surface 50b of housing unit 48b and viewed in the direction of a center of handheld machine tool battery charging device 10b, first charge coil 20b of primary inductive charging unit 12b is encountered to begin with, followed by second charge coil 22b of primary inductive charging unit 12b, core unit 46b of primary inductive charging unit 12b, a shielding unit 52b, and electronic unit 58b. Shielding unit 52b is provided to protect electronic unit 58b from interference effects of charge coils 20b, 22b, and vice versa. Electronic unit 58b is connected to the energy supply by a cable 54b (not shown further) (FIG. 4).

Battery charging device 10b of the handheld machine tool has a processing unit 26b, which analyzes at least one parameter of a nominal voltage of one of handheld machine tool battery devices 14b, 16b, 18b. Processing unit 26b analyzes a cell number of a cell unit 28b of handheld machine tool battery devices 14b, 16b, 18b. Processing unit 26b is provided to analyze a number of cell elements 42b of cell unit 28b of handheld machine tool battery devices 14b, 16b, 18b, and to infer a nominal voltage therefrom. Processing unit 26b is assigned to the two charge coils 20b, 22b of battery charging device 10b of the handheld machine tool. Processing unit 26b constitutes part of electronic unit 58b (FIG. 4).

In addition, electronic unit 58b of battery charging device 10b of the handheld machine tool has a control and/or regulator unit 80b, which controls a voltage that is flowing through charge coils 20b, 22b of primary inductive charging unit 12b, and adapts it to a nominal voltage of one of handheld machine tool battery devices 14b, 16b, 18b (FIG. 4).

Handheld machine tool battery charging device 10b furthermore has a communication unit 72b, which reads out at least one parameter of a nominal voltage of one of handheld machine tool battery devices 14b, 16b, 18b. Communication unit 72b analyzes a cell number of a cell unit 28b of handheld machine tool battery devices 14b, 16b, 18b. Communication unit 72b is connected to processing unit 26b. Communication unit 72b likewise makes up a part of electronic unit 58b. Communication unit 72b is embodied by an NFC interface. Handheld machine tool battery devices 14b, 16b, 18b likewise have a separate communication unit 74b for this purpose. Communication units 74b of handheld machine tool battery devices 14b, 16b, 18b are also embodied by an NFC interface in each case. Communication units 74b form part of an electronic unit 30b associated with individual handheld machine tool battery device 14b, 16b, 18b (FIG. 4).

Handheld machine tool battery devices 14b, 16b, 18b have a separate memory unit 76b, which is provided for the non-volatile storage of a number of cell elements 42b of individual cell units 28b of handheld machine toll battery devices 14b, 16b, 18b. Memory units 76b are embodied by a nonvolatile memory and constitute part of individual electronic unit 30b in each case. Memory units 76b are connected to respective communication unit 74b (not shown further). Via communication units 74b of handheld machine tool battery devices 14b, 16b, 18b, communication units 72b are able to read out a stored number and to transmit it to processing unit 26b. The nominal voltage of cell elements 42b is stored on processing unit 26b, which makes it possible for processing unit 26b to infer a nominal voltage of individual cell unit 28b (FIG. 4).

Primary inductive charging unit 12b is provided to actuate one of the two, or both, charge coils 20b, 22b as a function of a handheld machine tool battery device 14b, 16b, 18b to be charged. Primary inductive charging unit 12b is provided to actuate one of the two, or both, charge coils 20b, 22b as a function of a nominal voltage of a particular handheld machine tool battery device 14b, 16b, 18b to be charged. If one of battery devices 14b, 16b, 18b of the handheld machine tool is placed on charge surface 50b, communication unit 72b of primary inductive charging unit 12b reads out a number of cell elements 42b of handheld machine tool battery device 16b, using communication unit 74b of handheld machine tool battery device 16b seated on the charge surface. Processing unit 26b analyzes the number of cell elements 42b and uses it to calculate a nominal voltage. Because of the calculated nominal voltage, one of the two, or both, charge coils 20b, 22b is/are actuated in such a way that an appropriate nominal voltage is generated, either individually or jointly.

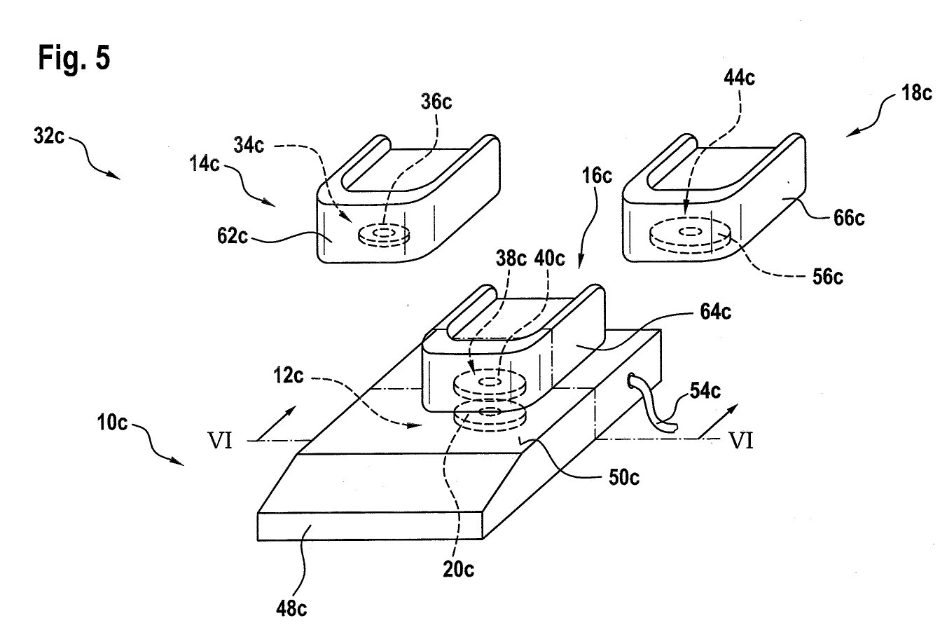

FIG. 5 shows a further alternative battery charging device 10c of a handheld machine tool according to the present invention, which includes a primary inductive charging unit 12c and three handheld machine tool battery devices 14c, 16c, 18c having a secondary inductive charging unit 34c, 38c, 44c in each case.

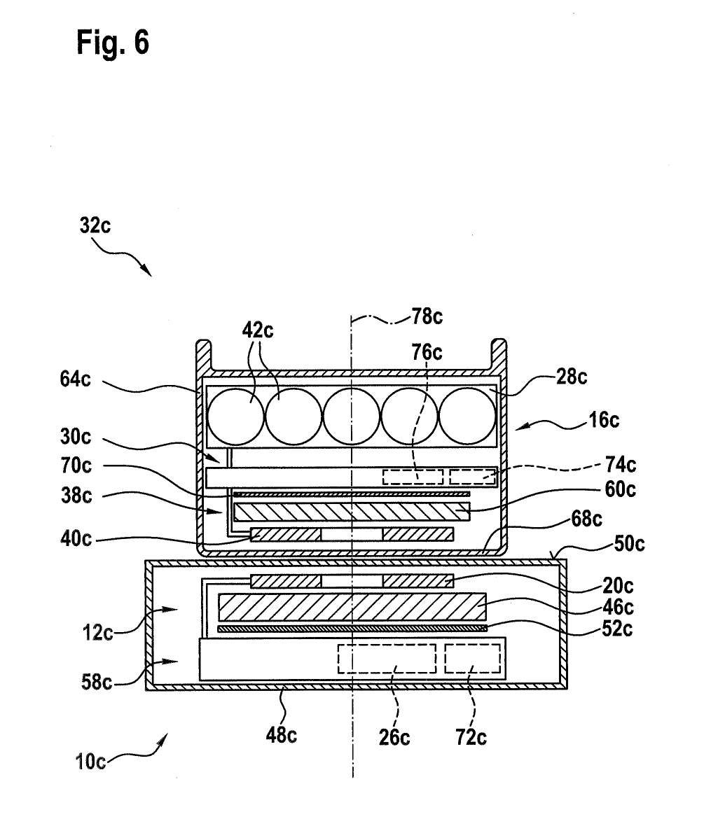

Primary inductive charging unit 12c has a charge coil 20c. Charge coil 20c charges one of handheld machine tool battery devices 14c, 16c, 18c using different nominal voltages. Charge coil 20c is developed in the form of a ring and made up of a plurality of electrical conductors, which extend in the circumferential direction. The electrical conductors are wound about a winding axis 78c in the circumferential direction. A core unit 46c and an electronic unit 58c are assigned to charge coil 20c. Core unit 46c is developed in the form of a plate and made from a magnetic material (FIG. 6).

Primary inductive charging unit 12c is situated completely inside housing unit 48c. Starting from charge surface 50c of housing unit 48c and viewed in the direction of a center of battery charging device 10c of a handheld machine tool, charge coil 20c of primary inductive charging unit 12c comes first, followed by core unit 46c of primary inductive charging unit 12c, shielding unit 52c, and electronic units 58c. Shielding unit 52c is provided to protect electronic unit 58c from interference effects of charge coil 20c, and vice versa. Electronic unit 58c is connected to a cable 54c for the energy supply (not shown further).

The three handheld machine tool battery devices 14c, 16c, 18c each have a cell unit 28c for energy storage. Cell units 28c are provided to supply energy to the handheld machine tools (not shown further) (FIG. 6).

Each handheld machine tool battery device 14c, 16c, 18c includes one of secondary inductive charging units 34c, 38c, 44c. Secondary inductive charging units 34c, 38c, 44c are provided for the wireless transmission of energy for a charging operation of cell units 28c. Secondary inductive charging units 34c, 38c, 44c have a charge coil 36c, 40c, 56c, respectively, and a core unit 60c. Charge coils 36c, 40c, 56c are developed in the form of a ring. Charge coils 36c, 40c, 56c are made up of a plurality of electrical conductors, which extend in the circumferential direction. The electrical conductors are wound about winding axis 78c in the circumferential direction. First handheld machine tool battery device 14c has secondary inductive charging unit 34c which is provided with first charge coil 36c. Second handheld machine tool battery device 16c has secondary inductive charging unit 38c provided with a second charge coil 40c, which differs from first charge coil 36c of first handheld machine tool battery device 14c. Third handheld machine tool battery device 18c has secondary inductive charging unit 44c provided with a third charge coil 56c, which differs from first charge coil 36c of first handheld machine tool battery device 14c and from second charge coil 40c of second handheld machine tool battery device 16c. Second charge coil 40c of second handheld machine tool battery device 16c has dimensions that differ from those of first charge coil 36c of first handheld machine tool battery device 14c. Second charge coil 40c of second handheld machine tool battery device 16c has a coil main extension that differs from that of first charge coil 36c of first handheld machine tool battery device 14c. Third charge coil 56c of third handheld machine tool battery device 18c has dimensions that differ from the dimensions of first charge coil 36c of first handheld machine tool battery device 14c and second charge coil 40c of second handheld machine tool battery device 18c. Third charge coil 56c of third handheld machine tool battery device 18c has a coil main extension that differs from that of first charge coil 36c of first handheld machine tool battery device 14c and second charge coil 40c of second handheld machine tool battery device 16c.

With the exception of a number of cell elements 42c of cell units 28c, and with the exception of the size of charge coils 36c, 40c, 56c, handheld machine tool battery devices 14c, 16c, 18c have the same design.

Charge coil 20c of primary inductive charging unit 12c of battery charging device 10c of the handheld machine tool is embodied by a standard charge coil. In addition, primary inductive charging unit 12c has a uniform charge voltage. A particular coil main extension of charge coils 36c, 40c, 56c of handheld machine tool battery devices 14c, 16c, 18c is selected in this way in order to transform a charge voltage into a required nominal voltage via a difference of the coil main extension of one of charge coils 36c, 40c, 56c, in relation to a coil main extension of charge coil 20c of battery charging device 10c of a handheld machine tool.

What is claimed is:

1. A battery charging device of a handheld machine tool, comprising:
a primary inductive charging unit provided to charge at least two battery devices of the handheld machine tool, using at least two different nominal voltages.

2. The battery charging device as recited in claim 1, wherein the primary inductive charging unit charges at least three battery devices of the handheld machine tool using at least three different nominal voltages.

3. The battery charging device as recited in claim 2, wherein the primary inductive charging unit has at least three charge coils which provide different nominal voltages to charge the at least three battery devices.

4. The battery charging device as recited in claim 3, wherein the primary inductive charging unit actuates a selected one of the three charge coils as a function of a selected one of the three battery devices to be charged.

5. The battery charging device as recited in claim 2, further comprising:
at least one processing unit provided to analyze at least one parameter of a nominal voltage of a selected one of the at least three battery devices.

6. The battery charging device as recited in claim 5, wherein the processing unit analyzes at least one of (i) a cell number of a storage cell unit of the selected one of the at least three battery devices, and (ii) a type of circuit of an electronic unit of the selected one of the at least three battery devices.

7. A system comprising:
at least one first battery device of a handheld machine tool;
at least one second battery device of the handheld machine tool; and
a battery charging device having a primary inductive charging unit provided to inductively charge the at least two battery devices of the handheld machine tool using at least two different nominal voltages.

8. The system as recited in claim 7, wherein the first battery device has a secondary inductive charging unit including a first charge coil, and the second battery device has a secondary inductive charging unit having a second charge coil which differs from the first charge coil of the first battery device.

9. The system as recited in claim 8, wherein dimensions of the second charge coil of the second battery device differ from dimensions of the first charge coil of first battery device.

10. The system as recited in claim 9, wherein at least one cell unit of at least one of the first and second battery devices includes at least one cell element using a voltage of at least approximately 3.6 Volts.
